(19) United States
(12) Patent Application Publication
(10) Pub. No.: US 2024/0106898 A1
(43) Pub. Date: Mar. 28, 2024

(54) CONNECTING A MACHINE

(71) Applicant: Talenco B.V., Antwerpen (BE)

(72) Inventor: GERRY BRUYNS, KONTICH (BE)

(73) Assignee: Talenco B.V., Antwerpen (BE)

(21) Appl. No.: 18/276,117

(22) PCT Filed: Feb. 7, 2022
(86) PCT No.: PCT/IB2022/051039

§ 371 Date: Aug. 7, 2023

(30) Foreign Application Priority Data
Feb. 8, 2021 (BE) 2021/5097

(51) Int. Cl. H04L 67/12; F21V 8/00; G01J 1/42

(52) U.S. Cl. CPC H04L 67/12; G01J 1/42; G02B 6/0006; G02B 6/003; G01J 2001/4247

(57) ABSTRACT

System for connecting a working machine comprising one or more light signal elements to an external server, wherein the system comprises one or more holding elements which are attachable to the light signal elements, wherein each holding element comprises a light sensor, which light sensor is provided to send a signal when a light intensity measured by the light sensor exceeds a predetermined threshold value and wherein communication means are provided operatively connected to the light sensor in order to send the signal to the external server.

The invention relates to a system for connecting a machine, for instance a working machine, to an external server.

Working machines are machines that are used in the manufacturing industry for manufacturing products. Working machines can be used in an indoor or outdoor setting to perform a task. Examples of working machines are CNC machines, lathes, injection moulding machines, cutting machines, bending machines, 3D printers, robots, excavators, mobile electrical boxes, and so on. A working machine is defined as a machine which is configured to at least partially take over physical labour from a person. More specifically, a working machine is typically configured to manipulate a physical product. More specifically, a working machine is defined in the context of a factory as a machine configured to machine a physical product.

Modern working machines are provided with a connection to a server. This facilitates monitoring of the working machine. More specifically, the state of the working machine can be established from a distance. When the working machine goes into a failure mode, this can be detected remotely and suitable actions can be taken. This allows maintenance and repair work to be scheduled taking into consideration the current status of the working machine. More specifically, when working machines are placed in a machine park, wherein a plurality of working machines are located together, it has great advantages when maintenance and repairs can be scheduled on the basis of statuses of multiple working machines.

A problem arises when an existing machine park is modernized. An existing machine park will typically include working machines which have not yet been provided with a connection to the server. In the past, these machines were monitored visually by an operator by visually determining the signals displayed by the machine. For this purpose most working machines have a post with a plurality of lights, more specifically a green, an orange and a red light placed one above the other. In the past, providing such a post for each working machine allowed a person responsible for the machine park to monitor a plurality of working machines from a control room by visually checking the lights. This is still relevant for many working machines, wherein an operator can establish the status of the machine on the basis of the lights that are on in a machine.

It is an object to connect such older working machines to an external server in a simple manner and without modifying the operation of the working machine to a considerable extent.

For this purpose the invention provides a system for connecting a machine comprising one or more light signal elements to an external server, wherein the system comprises one or more holding elements which can be attached to the light signal elements, wherein each holding element comprises a light sensor, which light sensor is provided to send a signal when a light intensity measured by the light sensor exceeds a predetermined threshold value and wherein communication means are provided operatively connected to the light sensor in order to send the signal to the external server.

The system provides a communication mechanism which can be installed at an existing working machine in extremely simple manner. The type or kind of working machine is less relevant, making the invention more broadly applicable to a machine as well. For the sake of clarity of the explanation, reference will be made in the description below to a working machine, however without this being intended in the first instance to limit the invention. The system interferes with neither the software nor the electric cabling of the working machine. The system can thereby be placed in extremely simple manner. The system provides for a reading of the state of the light signal elements by means of a light sensor. The signal can be generated directly or indirectly. A light sensor can thus be formed with one or more light-dependent resistors. These do not send a digital signal when a threshold value is exceeded, but ensure that a signal varies in accordance with the light intensity received. A microprocessor compares these signals to a threshold value and can then optionally provide for a message to the external server. The status of the working machine can hereby be monitored remotely. The light signals are still generated by the working machine as before, so that an operator who is familiar with and operates the working machine can continue doing so in the manner already known. In other words, the working machine is not interfered with directly, so that its operation and light signalling remain unchanged. The state of each light is however detected and sent to the server. The holding elements can take different forms, tensioning straps or clamps. For the sake of simplicity of the description reference will be made below to clamps. It will be apparent to the skilled person that the description can be applied wholly analogously to other types of holding element. The use of the word clamp as holding element is therefore not intended in the first instance to limit the invention.

The clamps are preferably substantially light-transmitting in order to allow the light signal to pass. Making the clamps light-transmitting allows the clamps to be clamped over and/or round the visible portion of the light of the working machine without this blocking the view for an operator. The operator can hereby see the status of the lights, even though the clamp extends partially or wholly over the light.

The light sensor and the communication means are preferably provided in a housing, wherein the light sensor is connected via a glass fibre to the clamp. Each clamp further preferably comprises a lens with connecting means for connecting the glass fibre in order to conduct light from the relevant light signal element via the lens into the glass fibre. A glass fibre is provided to conduct a light signal instead of conducting a current or voltage. By providing a glass fibre all electrical components can be placed in a housing situated some distance from the lights themselves. The cables coming from the housing are glass fibre cables. The advantage of glass fibre cables is that electromagnetic interferences, which can typically occur in or close to working machines, have no influence. A further advantage is related to explosion protection, more specifically because all electrical components are situated in a closed housing while the glass fibres, which do not transport electric charges, extend outside the housing to the machine. The light signal is transmitted by the glass fibre into the housing where the light sensor is provided. In this housing the light intensity of the light is measured via the sensor and the glass fibre.

The lens is preferably releasably connectable to the clamp. The system further preferably has a plurality of different clamps for attaching the lens to different sizes and types of light signal element. This increases the modularity and applicability of the system in that the clamps, and thereby the light sensor as well, can be connected to a plurality of different sizes and types of light signal element.

The system preferably has a processor for periodically controlling the light sensor to perform a measurement of the light intensity and to trigger the communication means to send the signal when the measured light intensity meets a predetermined criterion. Owing to this structure, electrical and electronic control is present only in the housing. Situated outside the housing is the light conductor, which is fully analog.

The invention further relates to a method for connecting a working machine comprising one or more light signal elements to an external server, wherein the method comprises of:
attaching one or more clamps to the light signal elements, wherein each clamp comprises a light sensor;
generating a signal when a light intensity measured by the light sensor exceeds a predetermined threshold value; and
sending a digital signal to the external server via communication means.

The method preferably comprises of conducting a light signal from the light signal elements which is transferred between the light signal elements and the light sensor through a light conductor.

The above stated advantages and effects are also applicable to the method.

The invention will now be further described on the basis of exemplary embodiments shown in the drawings.

In the drawing:

FIG. 1 shows an example of a traditional post with light signal elements which is provided with a system according to the invention;

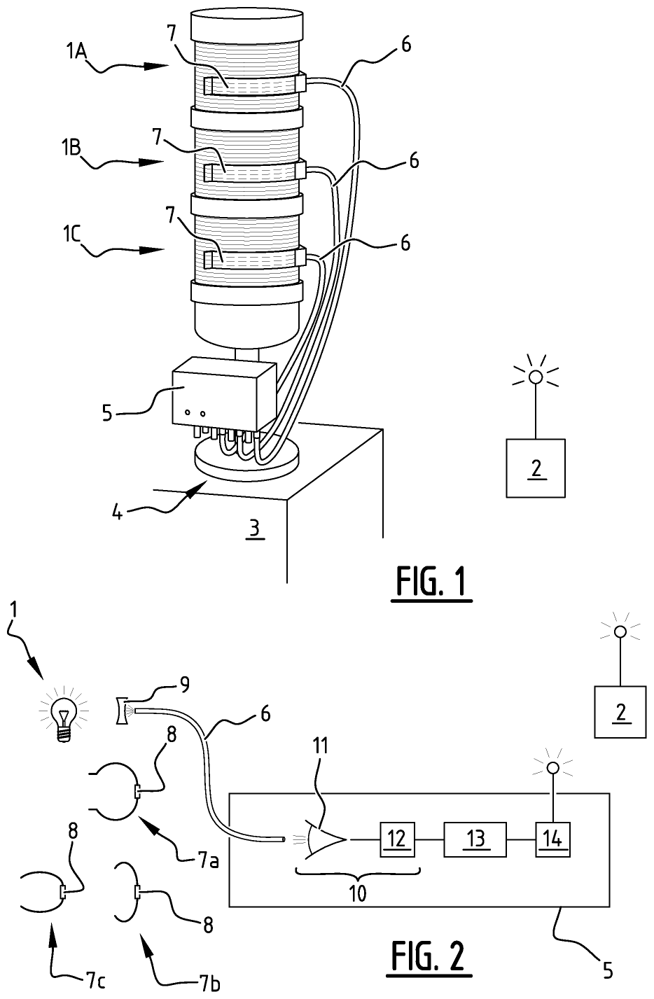

FIG. 2 shows a schematic structure of a system according to an embodiment of the invention; and

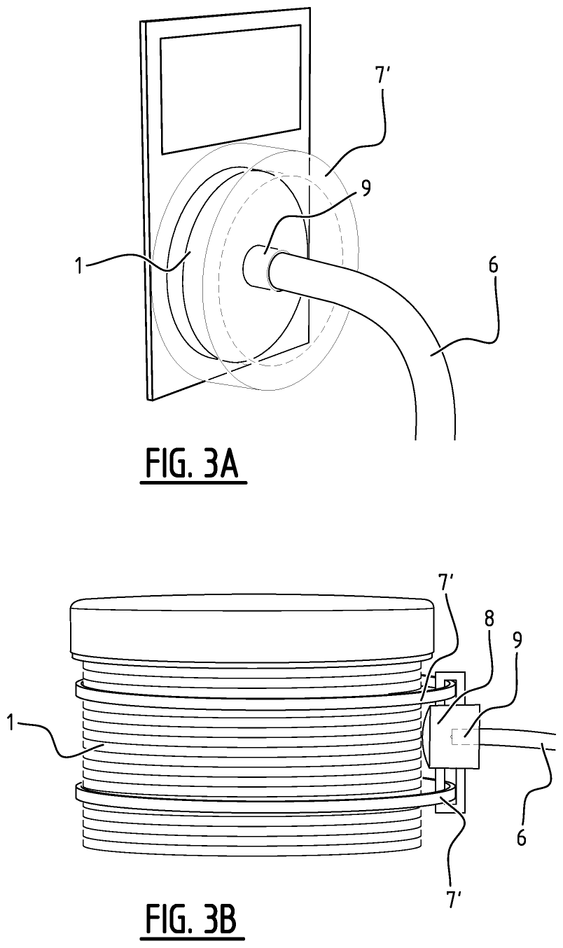

FIGS. 3a and 3b show different embodiments of a holding element with lens and glass fibre.

The same or similar elements are designated in the drawings with the same reference numerals.

The invention is based on the insight that older machine parks with working machines are difficult or impossible to connect by means of software to an external server. This means that the electrical and/or electronic structure of the working machines does not allow useful signals to be diverted to an external server in a simple or at least acceptable manner. In addition to technical reasons, there are also legal reasons, more specifically liability, at play when interfering with the hardware and/or software of a working machine.

The invention provides a system for still sending relevant signals from the working machine to a server without opening the working machine and without therefore interfering directly with hardware and/or software. A working machine is preferably a machine from the group comprising CNC machines, lathes, injection moulding machines, extrusion machines, intrusion machines, cutting machines, bending machines, 3D printers, robots, automated warehouses and so on. The working machine being provided with the system according to the invention is preferably a working machine wherein a digital connection such as an ethernet connection, network connection, USB connection or other type of communication bush is absent, or wherein the communication bush which is present is not or compatible, or is only compatible with difficulty, with existing systems.

FIG. 1 illustrates a working machine 3. The working machine 3 is provided with a small post 4 with a plurality of light signal elements 1A, 1B and 1C. Light signal element 1A is for instance a green light for indicating that working machine 3 is operating correctly. Light signal element 1B is for instance a red light for indicating that working machine 3 is not working. Light signal element 1C is for instance orange light for indicating that working machine 3 requires inspection and/or maintenance within a determined period of time. The skilled person will appreciate that the number of lights, the colour of the lights and the manner of mounting of the lights can differ from working machine to working machine. The invention is not limited to a determined type of light signal element.

FIG. 1 shows that each light signal element 1A, 1B, 1C is provided with a clamp 7. The clamp 7 is formed for clamping at least partially onto or around the light signal element 1A, 1B, 1C, such that a sensor can directly or indirectly detect a light signal emitted by the light signal element 1A, 1B, 1C. In the shown embodiment a glass fibre 6 is connected to each clamp 7. A glass fibre 6 is defined as wire used as light conductor. A glass fibre 6 is here preferably manufactured from glass. The glass fibre 6 typically has an opaque casing so that influence of light laterally incident on glass fibre 6 has little or no effect so as to limit interferences. A glass fibre 6 is known from the telecommunications industry for sending and receiving light signals. A lens is preferably provided at the position of clamp 7 in order to increase an amount of light from the light signal element in the glass fibre 6.

FIG. 1 further shows a housing 5. The elements in the housing are further elucidated with reference to FIG. 2. The housing comprises the functional elements for converting the light signals of the light signal elements into a digital signal to server 2. The state of working machine 3 can hereby be monitored remotely. More specifically, at least the light signals of the light signal elements can be monitored remotely. Maintenance and repair work can be scheduled on the basis thereof.

FIG. 1 shows that housing 5 can take a simple and compact form so as to be connected to the working machine 3 in a vicinity of the light signal elements 1A, 1B, 1C. Housing 5 can be provided with a battery for powering the operation of the components in the housing. Housing 5 can alternatively be connected to an external power supply.

FIG. 2 illustrates schematically the structure of the system according to an embodiment of the invention. In FIG. 2 the light signal element 1 is shown as a lamp. The figure shows a plurality of different clamps 7a, 7b, 7c. Each clamp has a holder 8 for receiving a lens 9. Each clamp 7 is preferably manufactured from a translucent or transparent plastic. Because a translucent or transparent clamp is provided, the clamp can be arranged partially or wholly over the light signal element 1 without the primary function thereof, this being to generate a light signal to an operator, being impeded to any appreciable extent. Each clamp is preferably constructed with two arms which are provided to together grip at least partially around a light signal element 1. The dimensions and the elastic deformability are here chosen such that the arms exert a clamping force on the light signal element 1 when the arms grip therearound, which clamping force is such that the clamp remains positioned with the lens 9 on the light signal element 1.

A clamp 7 can comprise further means for keeping a lens 9 positioned on the light signal element 1 in improved manner. A clamp can thus for instance have an adhesive zone at the distal ends of the arms so that the clamp 7 can be at least partially adhered over the light signal element 1.

The lens 9 is shown separately of the glass fibre 6 in FIG. 2. It will however be apparent that the lens 9 can also be integrated in an end of the glass fibre 6. Glass fibre 6 is held via clamp 7 in a vicinity of the light signal element 1 such that an end of the glass fibre 6 is directed toward the light signal element 1. Light generated by the light signal element 1 will hereby be received at least partially by the lens and transmitted via glass fibre 6 into housing 5. The principle of transmitting light via a glass fibre 6 is known and is therefore not further discussed in this description.

By using a lens 9 and glass fibre 6 in combination with a translucent or transparent clamp the visual impact of the system on the primary operation of the light signal elements is minimal. More specifically, the light signal is visually blocked to only minimal extent by the lens and glass fibre.

Providing in housing 5 is a light sensor 10. In the shown embodiment the light sensor is shown as analog sensor 11 which has an initial value, this can be a voltage or a resistance, depending on the amount of light incident on sensor 11. An analog/digital converter is then connected to this sensor 11 in order to obtain a digital value which is representative of the amount of light measured by light sensor 10. This digital value is interpreted by a processor 13 to decide whether a signal will be transmitted via a communication module 14 to server 2. The simplest form of a digital value is a 1 when the light is on and a 0 when the light is off. This can be realized with a light-sensitive diode as light sensor. The interpretation by processor 13 can be highly rudimentary, more specifically periodically transmitting a signal irrespective of the measured value. The interpretation can alternatively or additionally also be based on the size of the digital value, wherein a signal is for instance sent via the communication module 14 when the digital value exceeds a predetermined threshold value and/or drops below a predetermined threshold value. In this way an on/off signal of the light signal elements can be communicated to server 2 in extremely simple manner.

The skilled person will appreciate that other embodiments or configurations can also be provided. The light sensor can thus be directly connected to the clamp 7 in order to directly generate an electrical analog or even digital signal at the light signal element. This signal can then be further processed and/or sent by a processor 13 and/or communication module 14 for communicating to a server 2. In this embodiment the light sensor is not provided in housing 5 but at clamp 7.

FIG. 3a shows an alternative embodiment wherein the holding element is formed as a transparent dome which can be placed over a light signal element. Because the dome is transparent, the light signal element remains visible for an operator. The dome can be adhered temporarily or permanently over the light signal element. The glass fibre 6 is connected to the dome, typically via a lens 9.

FIG. 3b shows a further alternative embodiment wherein the holding element is formed to extend around a light signal element. The holding element can here comprise two parts, these being on the one hand a holder 8 for holding the lens 9 with the glass fibre 6, and on the other hand a cable tie or elastic band or similar element for pressing holder 8 against the light signal element 1. By providing the holder with openings 8 through which the cable ties or elastic bands can pass, or structures on which they can engage, cable ties or elastic bands of different lengths can be used to hold the same holder 8 against a light signal element. This provides an alternative to providing different clamps as shown in FIG. 2 and described above.

The skilled person will appreciate on the basis of the above description that the invention can be embodied in different ways and on the basis of different principles. The invention is not limited to the above described embodiments. The above described embodiments and the figures are purely illustrative and serve only to increase understanding of the invention. The invention will not therefore be limited to the embodiments described herein, but is defined in the claims.

1. A system for connecting a machine comprising one or more light signal elements to an external server, the system comprising:
one or more holding elements attachable to the light signal elements, wherein each holding element comprises a light sensor, which light sensor is provided to send a signal when a light intensity measured by the light sensor exceeds a predetermined threshold value, and
communication means operatively connected to the light sensor to send the signal to the external server.

2. The system according to claim 1, wherein the holding elements are substantially light-transmitting in order to allow the light signal to pass.

3. The system according to claim 1, wherein the light sensor and the communication means are provided in a housing and wherein the light sensor is connected via a glass fibre to the holding element.

4. The system according to claim 3, wherein each clamp comprises a lens with connecting means for connecting the glass fibre in order to conduct light from the relevant light signal element via the lens into the glass fibre.

5. The system according to claim 4, wherein the lens is releasably connectable to the holding element.

6. The system according to claim 5, wherein the system has a plurality of different holding elements for attaching the lens to different sizes and types of light signal element.

7. The system according to claim 1, wherein the system has a processor for periodically controlling the light sensor to perform a measurement of the light intensity and to trigger the communication means to send the signal when the measured light intensity meets a predetermined criterion.

8. The system according to claim 1, wherein the one or more holding elements comprise a clamp.

9-10. (canceled)
